(19) United States
(12) Patent Application Publication
(10) Pub. No.: US 2025/0278076 A1
(43) Pub. Date: Sep. 4, 2025

(54) PROCESS LINE CHANGEOVER

(71) Applicant: SWIMC LLC, Cleveland, OH (US)

(72) Inventors: William C. Upton, Lebanon, PA (US); Richard D. Hudson, North Olmsted, OH (US); Erin H. Jayjack, South Lebanon, OH (US); Anthony B. Sharrotta, Aurora, OH (US); Flavio Lacerda, Asa Norte (BR)

(21) Appl. No.: 18/774,227

(22) Filed: Jul. 16, 2024

Related U.S. Application Data
(60) Provisional application No. 63/560,168, filed on Mar. 1, 2024.

(51) Int. Cl. G05B 19/418

(52) U.S. Cl. CPC G05B 19/41865; G05B 2219/32077

(57) ABSTRACT

Described herein are methods for performing changover of a production line from a first product to a second product. One method involves assigning changover codes to the first product and second product and determining a wash type for the changover. A second method involves receiving a plurality of batch production orders for a plurality of products. Wash types for different sequences of the batch production orders are determined and a sequence is selected that reduces the amount of time for washing the line during changeovers. A third method involves transferring a product to a fill station prior to receiving quality control test results. The product is held at the fill station prior to the receipt of the test results. If the product passes the quality control test then the product is distributed by the fill station; otherwise, the product fails the quality control test, the product is quarantined.

### TECHNICAL FIELD

The present disclosure relates generally to batch processing and in particular embodiments to line changeover in the paint manufacturing process.

### BACKGROUND

Line changeover occurs upon changing the product being manufactured by a production line. For example, in the paint manufacturing process, line changeover can occur when changing the color, shade, or gloss of the paint being produced. Line changeover directly impacts the entire production value chain.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein a method for determining a wash type to be performed for a line changeover. The first (or current) product having a first code corresponding to properties of the first product and the second (or next) product having a second code corresponding to second product. A lookup is performed to obtain the appropriate wash type for the combination of the first product followed by the second product and the appropriate wash type is performed.

In accordance with an example embodiment, there is disclosed herein a method for scheduling production batches based on wash types. A plurality of batches are provided and the wash types (and consequently time) is determined for different sequences of batches. A sequence that reduces wash time is selected.

In accordance with an example embodiment, there is disclosed herein a method for accelerating the fill process after a batch is completed. The product is moved to a fill station while it is being tested. If the product is approved, the product is dispensed, otherwise, the product is quarantined and/or otherwise disposed.

### BRIEF DESCRIPTION OF THE DRAWINGS

The accompanying drawings incorporated herein and forming a part of the specification illustrate the example embodiments.

FIG. 1 is a block diagram of a system that employs an automated cleanout component in accordance with an example embodiment.

FIG. 2 is a table illustrating an example of Formal Digital Changeover Codes

FIG. 3 is a table illustrating example wash types.

FIG. 4 is an example of a system that can employ an accelerated fill check.

FIG. 5 illustrates an example of a paint production line.

FIG. 6 is a block diagram illustrating an example of a pant production Ine.

FIG. 7 is a block diagram illustrating an example of a method of selecting wash types.

FIG. 8 is a block diagram illustrating a method of scheduling batch jobs to reduce wash time.

FIG. 9 is a block diagram illustrating a method for accelerated fill check.

FIG. 10 is a computer system upon which an example embodiment can be implemented.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Described in example embodiments herein are methods for line changeover for a process. Although the description herein describes the methods implementing a paint manufacturing process, those skilled in the art can readily appreciate that the features described herein can be adapted to any manufacturing process that employs liquids dry materials, and/or gases in the production of a product, therefore, this disclosure should not be construed as limited to paint manufacturing.

Described in an example embodiment herein is an automated cleanout component that performs the cleanout steps defined based on the wash types. Batch processes comprises a formula (or recipe) and a code referred to herein as a Formal Digital Changeover Code (“FDCC”). Batch processes are monitored and upon determining a changeover has been initiated. When the changeover is initiated, the controller identifies the current batch process's formula and the next batch process's formula and their associated Formula Digital Changeover Codes. Based on the Formal Digital Changeover Codes, the wash type and the associated steps are retrieved from a database. The changeover steps are communicated to the filler computer, equipment PLCs, and operator interface.

Described in an example embodiment herein is a scheduling tool. Orders are received for batches to be made. The Scheduling Tool provides visibility and control of orders in the manufacturing process. The Scheduling Tool arranges orders for filling based on wash types to reduce the time spent on washing equipment. An example of this would be to have several NO WASH transitions in a row and then have the schedule provide a SIMPLE WASH or FULL WASH. This can help maintain cleanliness of the filler and prevent unintended failed fill checks. In particular embodiments, scheduling tool will automatically sequence orders to minimize wash times before processing the batches.

Described in an example embodiment herein is an Accelerated Fill Check that provides product to the filling line before the quality fill check has been approved. Accelerated fill check becomes active based on approved Formula Digital Changeover Code transitions and the incoming formula is not on the exclusion list. The exclusion list includes formulas that have the potential of their viscosity measurements changing before filling has begun. Accelerated fill check integrates quality lab testing to the filling line operations. If accelerated fill check is approved at the beginning of a changeover an interlock is enabled at the end of the filling line. Product will not be permitted to release from the line until the quality check has passed, or in the case of a failure, the product produced in the batch can be quarantined. Additionally in the case of a failure, the infeed to the filler is also closed to prevent further filling of failed product.

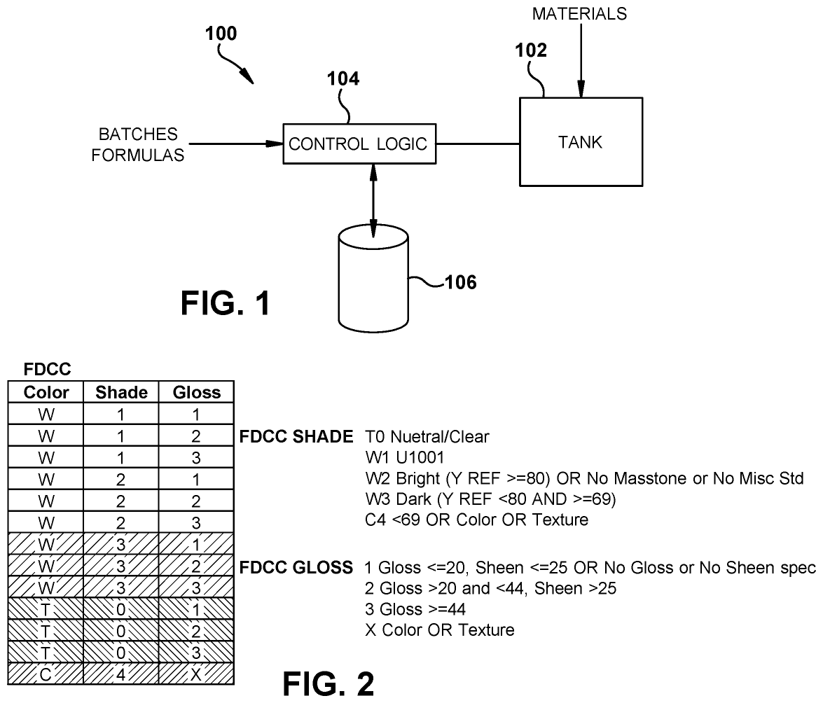

FIG. 1 is a block diagram of a system 100 that employs an automated cleanout component in accordance with an example embodiment. The system comprises a tank that receives materials and produces a product. As those skilled in the art can readily appreciate, this is a very simplified example as other embodiments may include multiple tanks for mixing, heating, cooling and/or any other process that can be employed in the manufacture of a product.

Control logic 104 controls the operations in the tank 102 and performs the functionality described herein. “Logic”, as used herein, includes but is not limited to hardware, firmware, software and/or combinations of each to perform a function(s) or an action(s), and/or to cause a function or action from another component. For example, based on a desired application or need, logic may include a software-controlled microprocessor, discrete logic such as an application specific integrated circuit (ASIC), a programmable/programmed logic device, memory device containing instructions, or the like, or combinational logic embodied in hardware. Logic may also be fully implemented in software that is embodied on a tangible, non-transitory computer-readable medium that performs the described functionality when executed by one or more processors. The control logic 104 is coupled with a database 106.

In operation, the control logic 104 receives data representative of batches that comprises formulas or the batch process for manufacturing of the product. The batches may be for different products, thus the same equipment can be used for multiple different products. Using paint as an example, a paint manufacturing facility can make many different paints. The paints can have different colors, shade, or gloss. FIG. 2 is an example of different properties paint can have.

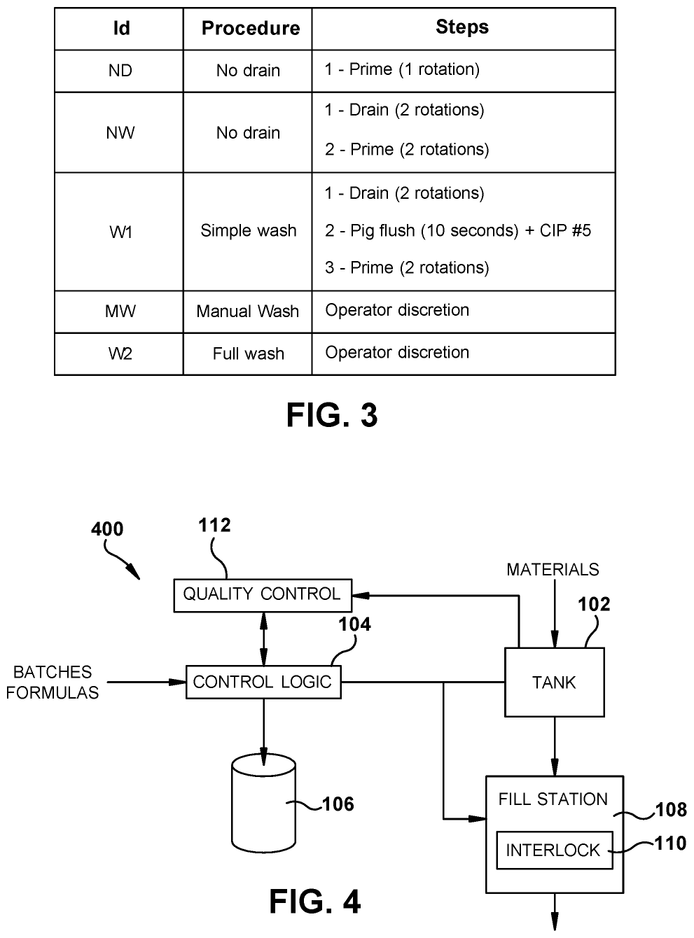

In accordance with an example embodiment, when line changeover occurs, the control logic 104 determines the FDCC code for the current batch and the FDCC for the next batch. The control logic 104 employs database 106 to determine the wash type for the changeover. FIG. 3 illustrates an example of different wash types and these steps. In the illustrated example, the wash types are No Drain (ND), No Wash (NW), Simple Wash (W1), Manual Wash (MW), and Full Wash (W2). A feature of the example embodiments described herein, is that by not performing a full wash at every changeover, this can save time and thus increase production.

In an example embodiment, control logic 104 is operable to obtain data representative of several batches for several products. Some products may have multiple batches. The control logic 104 determines the wash type (and consequently the time for the wash) for the different batches and arranges the batches into a sequence that reduces the time spent on washing the line (e.g., tank 102) and therefore improve the efficiency of the production line.

FIG. 4 is an example of a system 400 that can employ an accelerated fill check. Upon completion of a batch, product begins moving from the tank 102 to the fill station 108. This enables changeover to begin sooner and reduce the amount of time between batches. An interlock 110 prevents the product from being distributed until testing is completed.

A sample of the product is tested for quality control (QC) 112. If the product passes the test, the control logic 104 releases the interlock and allows the product to be dispensed. If however, the product fails testing, the product is quarantined and disposed.

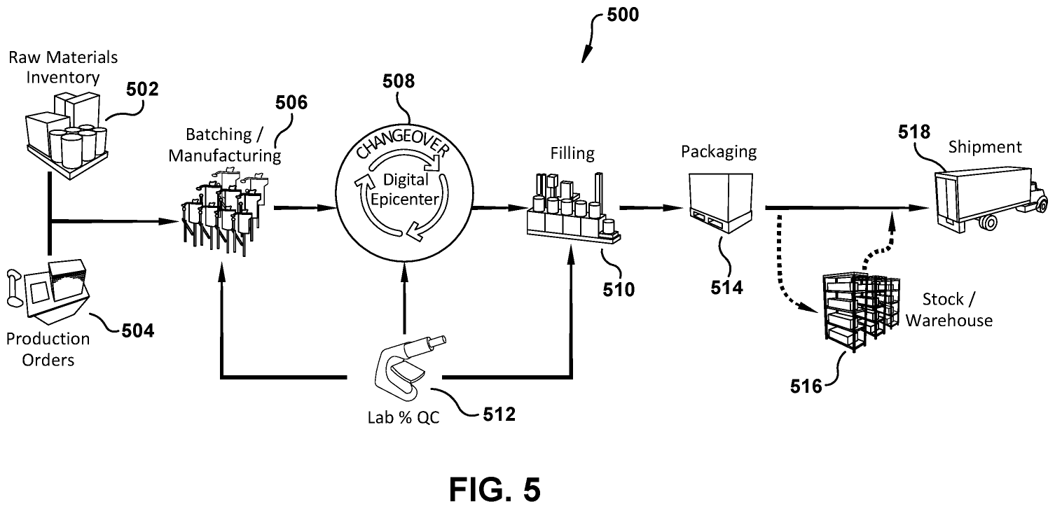

FIG. 5 illustrates an example of a paint production line 500. Raw materials, represented by 502, and production orders, represented by 504, are received at the batching/manufacturing facility, represented by 506.

Upon completion of a batch, changeover begins as represented by 508. The changeover 508, can employ any of the methods described herein to reduce changeover time and/or the time between batches.

Quality control tests, as represented by 512, are performed on the product. In embodiments that employ accelerated fill check as described herein, product can be moved to the fill station, represented by 510, while testing is performed. If the product passes the quality control tests 512, the product is released and moved to packaging 514, and then to stack/warehouse 516 and/or shipping 518. Of the product fails the quality control tests 512, the product is quarantined and not distributed at the filling station 510.

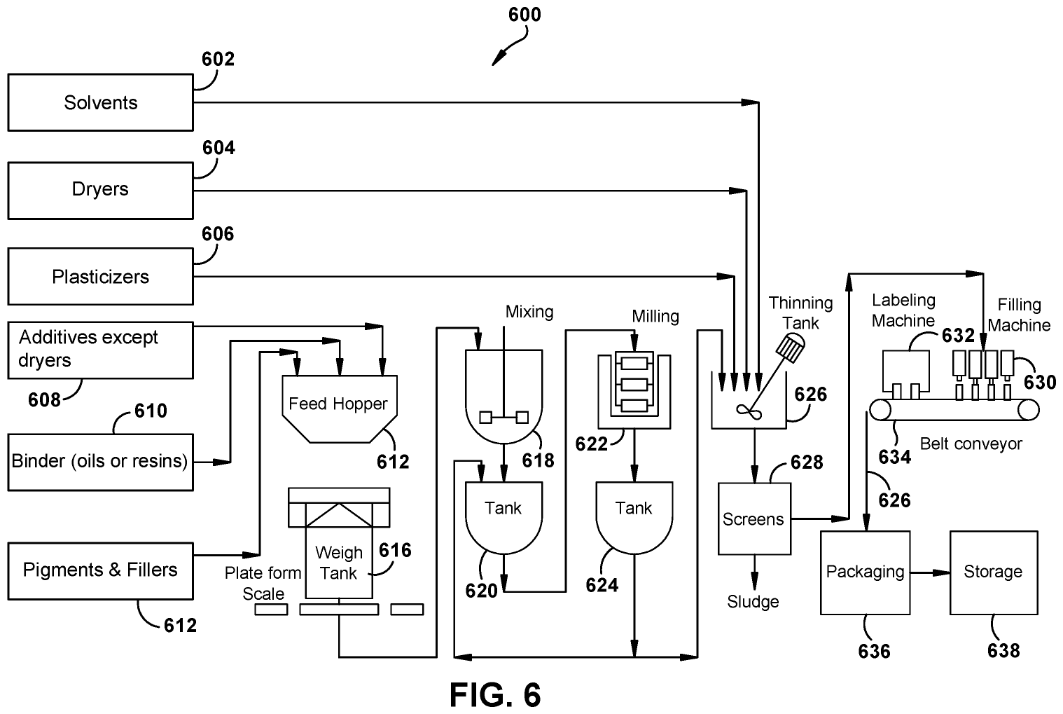

FIG. 6 is a block diagram illustrating an example of a pant production line. Note, some of the illustrated features may not be present in some embodiments and other embodiments may have additional features.

Solvents, 602, driers 604, and plasticizers 606 are provided to thinning tank 626. Additives (except driers 604) 608, binders (oils and/or resins) 610, and pigments and fillers 612 are provided to feed hopper 614 and then to weigh tank 616.

The additives 608, binders 610, and pigments 612 are forwarded to mixing 618 and tank 620. From tank 620, additives 608, binders 610, and pigments 612 are milled, represented by 622 and then to tank 624. In an example embodiment, the mixing and milling processes are performed more than once.

The additives 608, binders 610, and pigments 612 are combined with the solvents, 602, driers 604, and plasticizers 606 in the thinning tank 626. The batch is then screened by screener 628 and sludge is removed from the product. The product is then sent to the filling station 630, labeling machine 632, and moved by conveyer belt 634 to packaging 636. From packaging 636, the product is moved to storage 638 and/or shipping.

During changeover, any of tanks 616, 620, 624, and 626 can be cleaned based on the wash type determined using the methods described herein. In an example embodiment, accelerated fill check can be employed and product can be moved from the thinning tank 626 to the fill station 630 while quality control testing is performed as described herein.

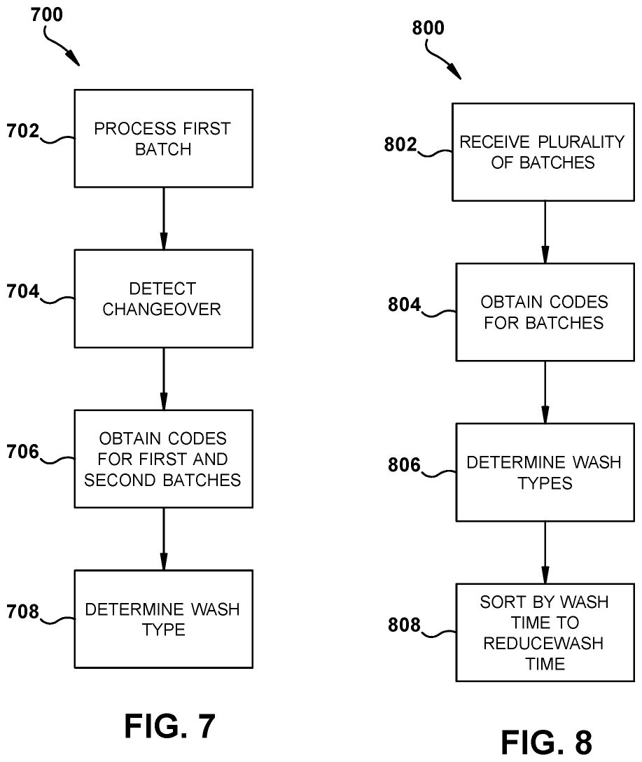

In view of the foregoing structural and functional features described above, methodologies in accordance with example embodiments will be better appreciated with reference to FIGS. 7-9. While, for purposes of simplicity of explanation, the methodologies of FIGS. 7-0. are shown and described as executing serially, it is to be understood and appreciated that the example embodiments are not limited by the illustrated order, as some aspects could occur in different orders and/or concurrently with other aspects from that shown and described herein. Moreover, not all illustrated features may be required. The methodology described herein is suitably adapted to be implemented in logic, such as hardware, software stored on a computer readable medium when executed by at least one processor, or a combination thereof.

FIG. 7 is a block diagram illustrating an example of a method 700 of selecting wash types. Method 700 can be implemented by control logic 104 in FIGS. 1 and 4.

At 702, a first (or current batch) is in progress and producing a first product. For example, a paint having a first color, shade, and gloss.

At 704, upon determining the first batch is completed, a changeover occurs. Part of the changeover process involves cleaning the equipment (e.g., thank 102 in FIGS. 1 and 4) before starting the second batch to prevent contamination.

At 706, the FDCC for the first (current) batch and the second (next) batch are obtained. An example of FDCC codes is illustrated in FIG. 2. The codes are dependent upon the product being manufactured.

At 708, the wash type is determined for the changeover. In an example embodiment, the wash types for the different combinations of FDCC codes are stored in a database. The appropriate wash type is then performed before beginning the second (next) batch. An example of the different wash types and steps involved is provided in FIG. 3.

FIG. 8 is a block diagram illustrating an example of a method 800 of scheduling batch jobs to reduce wash time. Method 800 can be implemented by control logic 104 in FIGS. 1 and 4.

At 802, a plurality of batches corresponding to products is received. Some products may have multiple batches. The plurality of products have a corresponding formular or process for transforming the materials into the finished product. The batches can be for any desired time period, such as for example a daily production or for a shift.

At 804, codes, such as FDCC codes, are obtained for the plurality of products. The code corresponds to characteristics of the product. For example, in FIG. 2, an example of FDCC codes for paints are illustrated. The codes correspond to the color, shade, and gloss of the product.

At 806, the wash types for different combinations of the plurality of batches are determined. The wash types for different sequences of the plurality of batches are then determined. FIG. 3 illustrates an example of wash types for paint production and the actions for each wash type.

At 808, a sequence that reduces the total amount of wash time for the plurality of batches is selected. Production then begins with the batches being processes in the selected sequence.

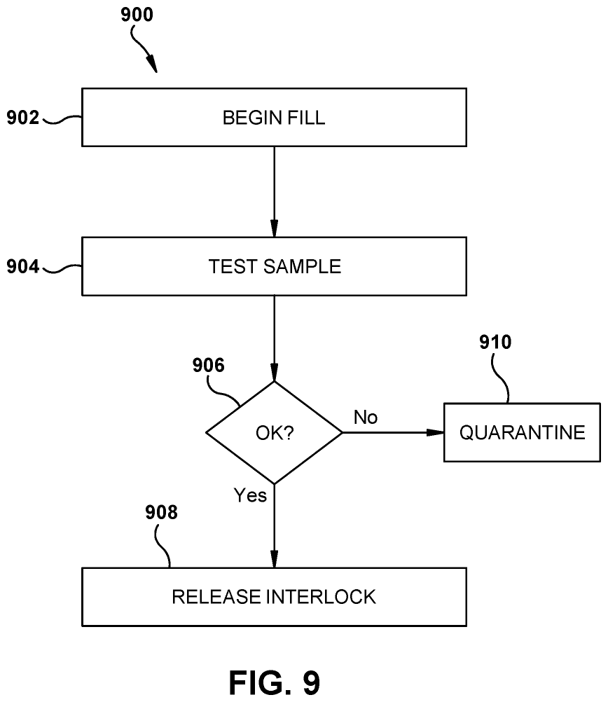

FIG. 9 is a block diagram illustrating an example of a method 900 for accelerated fill check. Method 700 can be implemented by control logic 104 in FIGS. 1 and 4.

At 902, upon completion of a batch, the product is moved from the tank to the fill station. Once the product has been moved to the fill station, changeover can begin. This saves time over methods where the product is held in the tank until testing is completed, which can result in more time available for the production line to process batches.

At 904, quality control testing begins. An interlock at the fill station prevents the product from being distributed until testing is completed. At 906, a determination is made whether the product passed quality control testing.

If, at 906, the product passes the quality control tests (YES), at 908 the interlock is released and the product is distributed. If, at 906, the product fails the quality control tests (NO), at 910, the product is quarantined and/or disposed without being distributed.

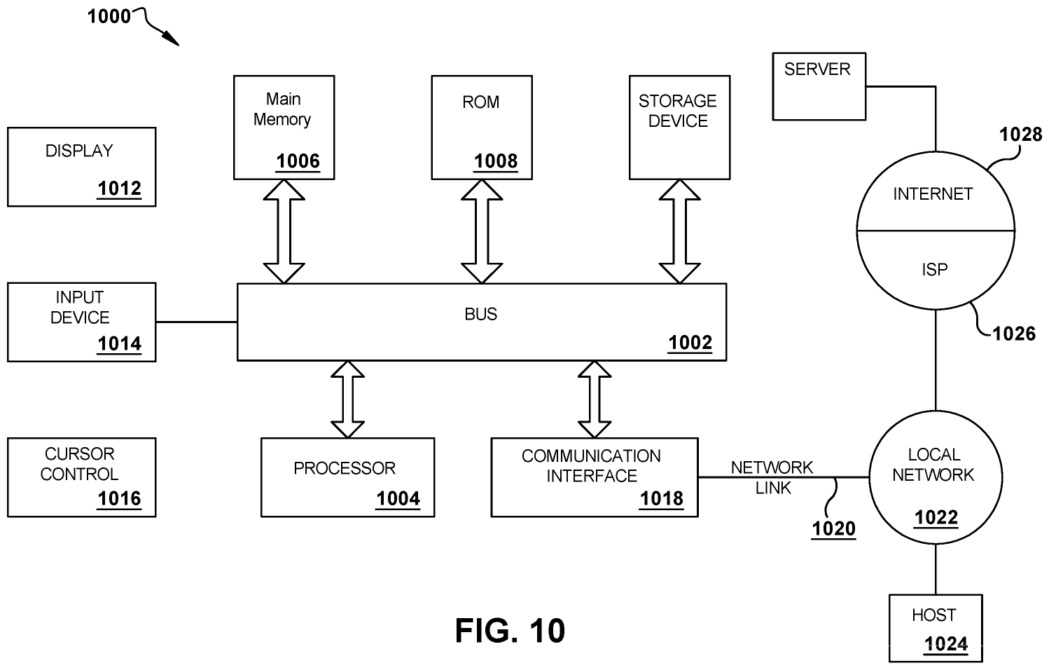

FIG. 10 is a block diagram that illustrates a computer system 1000 upon which an example embodiment may be implemented. Computer system 1000 can be employed for implementing the control logic 104 described in FIGS. 1 and 4 and/or implanting any or all of methods 700, 800, 900 described in FIGS. 7, 8, 9 respectively.

Computer system 1000 includes a bus 1002 or other communication mechanism for communicating information and a processor 1004 coupled with bus 1002 for processing information. Computer system 1000 also includes a main memory 1006, such as random access memory (RAM) or other dynamic storage device coupled to bus 1002 for storing information and instructions to be executed by processor 1004. Main memory 1006 also may be used for storing a temporary variable or other intermediate information during execution of instructions to be executed by processor 1004. Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012 such as a cathode ray tube (CRT) or liquid crystal display (LCD), for displaying information to a computer user. An input device 1014, such as a keyboard including alphanumeric and other keys is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g. x) and a second axis (e.g. y) that allows the device to specify positions in a plane. In an example embodiment, the input device 1014 is a touch screen.

An aspect of an example embodiment is related to the use of computer system 1000 for process line changeover. According to one embodiment, process line changeover is provided by computer system 1000 in response to processor 1004 executing one or more sequences of one or more instructions contained in main memory 1006. Such instructions may be read into main memory 1006 from another computer-readable medium, such as storage device 1010. Execution of the sequence of instructions contained in main memory 1006 causes processor 1004 to perform the process steps described herein. One or more processors in a multi-processing arrangement may also be employed to execute the sequences of instructions contained in main memory 1006. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 704 for execution. Such a medium may take many forms, including but not limited to non-volatile media. Non-volatile media include for example optical or magnetic disks, such as storage device 710. Common forms of computer-readable media include for example RAM, PROM, EPROM, FLASHPROM, CD, DVD, SSD or any other memory chip or cartridge, or other medium from which a computer can read.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic, or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communications through the worldwide packet data communication network, now commonly referred to as the “Internet” 1028. Local networks 1022 and Internet 1028 both use electrical, electromagnetic, or optical signals that carry the digital data to and from computer system 1000, are exemplary forms of carrier waves transporting the information.

Described above are example embodiments. It is, of course, not possible to describe every conceivable combination of components or methodologies for purposes of describing the example embodiments, but one of ordinary skill in the art will recognize that many further combinations and permutations of the example embodiments are possible. Accordingly, it is intended to embrace all such alterations, modifications and variations that fall within the spirit and scope of any claims filed in applications claiming priority hereto interpreted in accordance with the breadth to which they are fairly, legally and equitably entitled.

1. A method, comprising:
assigning changeover codes to paints based on characteristics of the paints;
producing a first paint having a first characteristic in a line;
producing a second paint having a second characteristic in the line; and
performing a line changeover after producing the first paint and before producing the second paint, the line changeover comprises:
determining a wash type to be performed on the line based on a set of rules for comparing first characteristic with the second characteristic, and
selectively cleaning the line employing the determined wash type.

2. The method according to claim 1, wherein the wash type is selected from a group consisting of no drain, no wash, simple wash, full wash, and manual wash.

3. The method according to claim 2, wherein the selected wash type is no drain.

4. The method according to claim 2, wherein the selected wash type is no wash.

5. The method according to claim 2, wherein the selected wash type is simple wash.

6. The method according to claim 2, wherein the selected wash type is full.

7. The method according to claim 2, wherein the selected wash type is manual wash.

8. The method according to claim 1, wherein the characteristics comprises color.

9. The method according to claim 1, wherein the characteristics comprises color and shade.

10. The method according to claim 1, wherein the characteristics comprise color, shade, and gloss,

11. The method according to claim 1, further comprising:
producing a third paint having a third characteristic;
determining a second wash type to be performed on the line based on a set of rules for comparing first characteristic with the third characteristic;
determining a third wash type to be performed on the line based on a set of rules for comparing second characteristic with the third characteristic;
determining a changeover time for the first wash type;
determining a changeover time for the second wash type;
determining a changeover time for the third wash type;
scheduling production of the first paint, second paint, and third paint based in an order that minimizes a total changeover times for producing the first paint, the second paint, and the third paint.

12. The method of claim 1, further comprising:
producing at least one additional paint having a third characteristic;
determining a plurality of additional wash types to be performed based on comparing the characteristics of the at least one additional paint with the first characteristic, the second characteristic, and with each other;
determining a changeover time between the first wash type and the plurality of different wash types;
scheduling production of the first paint, second paint, and at least one additional paint based on an order that minimizes a total changeover times for producing the first paint, the second paint, and the at least one additional paint.

13. The method according to claim 1, further comprising:
priming fill lines with the second paint prior to the second paint being tested;
holding the second paint in the fill lines until testing is completed; and
releasing the second paint from the fill lines upon approval based on the tests.

14. An apparatus, comprising:
a tank where materials are processed to create a product;
control logic coupled with the tank and operable to control the operations in the tank; and
a database coupled with the control logic;
the control logic is operable to determine a changeover from a first batch process for producing a first product to a second batch process for producing a second product;
the control logic is operable to determine a first changeover code for the first product and a second changeover code for the second product;
the control logic is operable to determine from the database a wash type based on the first changeover code and the second changeover code; and
the control logic is operable to cause the tank to be washed in accordance with the wash code.

15. The apparatus of claim 14, wherein the first and second products are the same

16. The apparatus of claim 14, wherein the wash type is selected from a group consisting of no drain, no wash, simple wash, full wash, and manual wash.

17. An apparatus, further comprising:
a tank where materials are processed to create a product;
control logic coupled with the tank and operable to control the operations in the tank; and
a database coupled with the control logic;
the control logic is operable to receive a plurality of batch productions requests that comprises a first batch having a first formula for producing a first product having a first changeover code; a second batch having a second formula for producing a second product having a second changeover code, and a third batch having a third
the control logic is operable employ the database to determine a first wash type based on a first sequence of the first changeover code and the second change over code, a second wash type based on a sequence of the second changeover code and the third changeover code, a third wash type for a third sequence of the third changeover code and the first changeover code, a fourth wash type based on a sequence of the second changeover code and the first changeover code, a fifth wash type based on a sequence of the third changeover and the second changeover code, and a sixth wash type based on a sequence of the third changeover code and the first changeover code; and
the control logic is operable to selectively scheduling production of the first batch, second batch, and third batch based by selecting from the first sequence, second sequence, third sequence, fourth sequence and fifth sequences a sequence that reduces total changeover times for producing the first product, the second product, and the third product based on the first wash type, second wash type, third wash type fourth wash type, fifth wash type, and sixth wash type.

18. The apparatus of claim 17,
wherein the first product is a first paint having a first color, a first shade, a first gloss, and the first changeover code is based on the first color, the first shade, and the first gloss;
wherein the second product is a second paint having a second color, a second shade, and a second gloss, the second changeover code is based on the second color, the second shade, and the second gloss; and
the third product is based having a third paint having a third color, a third shade, and a third gloss, and the third changeover code is based on the third color, the third shade, and the third gloss

19. An apparatus, comprising:
a tank where materials are processed to create a product;
control logic coupled with the tank and operable to control the operations in the tank; and
a fill station that comprises an interlock coupled with the tank;
the control logic is operable to transfer a first product produced from a first batch from the tank to the fill station prior to receiving quality control test results for the first product;
the control logic is operable to receive data representative of test results for the first product; and
the control logic is operable to release the interlock and allow distribution of the first product upon determining the data representative of the test results indicating the first product is satisfactory.

20. The apparatus of claim 19, further comprising:
the control logic is operable to transfer a second product produced by a second batch from the tank to the fill station prior to receiving quality control test results for the second product; and
the control logic is operable to prevent distribution of the first product upon determining the data representative of the test results indicating the second product is unsatisfactory.
